(19) United States
(12) Patent Application Publication
(10) Pub. No.: US 2002/0092690 A1
(43) Pub. Date: Jul. 18, 2002

(54) Method and apparatus for starting a vehicle

(76) Inventors: Uwe Benz, Uhldingen-Muehlhofen (DE); Klaus Graage, Kirchheim/Teck (DE); Gerald Hornburg, Holzmaden (DE); Josef Sonntag, Kirchheim/Teck (DE); Detlef Zur Megede, Kirchheim/Teck (DE)

Correspondence Address: CROWELL & MORING LLP, Intellectual Property Group, P.O. Box 14300, Washington, DC, 20044-4300, US

(21) Appl. No.: 09/997,250

(22) Filed: Nov. 30, 2001

(30) Foreign Application Priority Data
Nov. 30, 2000 (DE) 100 59 416.6

(51) Int. Cl. B62D 1/24; B60K 1/00

(52) U.S. Cl. 180/167; 180/65.3

(57) ABSTRACT

A system for starting a vehicle operated particularly by means of a fuel cell system includes devices for the arbitrary initiation of a starting operation of the fuel cell system or of a starting preparation of the vehicle independently of the presence of a driver in the direct proximity of the vehicle, particularly inside the vehicle.

### BACKGROUND AND SUMMARY OF THE INVENTION

This application claims the priority of German patent document no. 100 59 416.6, filed Nov. 30, 2000, the disclosure of which is expressly incorporated by reference herein.

The present invention relates to a method and apparatus for starting a vehicle that is operated by means of a fuel cell system.

An article by P. Agarwal in IEEE Transactions on Power Apparatus and Systems, 88 (1969) 2, Pages 86 to 93 discloses a vehicle driven by an electric motor supplied with electric energy by means of fuel cells; while German Patent Document DE 41 01 795 A1 suggests a vehicle borne fuel cell system having a compressor arranged in a feed line, for compressing the oxidant mass flow. Finally, German Patent Document DE 43 22 767 C2 discloses a system for starting a vehicle with an electric drive unit supplied with electric energy by a fuel cell. In the latter disclosure, a compressor driven by an electric motor and a starter motor compresses the oxidant mass flow in the feed line of the fuel cell. The starter motor is supplied by a starter battery, and the electric motor is supplied with voltage by the fuel cell.

In the previously developed vehicles driven by fuel cells, which generate the hydrogen required for operating the fuel cells by means of an on-board reformer, the required starting time (that is, the time from the start of the system to the actuating starting of the vehicle) are unacceptably high. The reason is, among other things, that the individual components of the fuel cell system, particularly a reformer or the fuel cells themselves, must first be brought to a defined operating temperature.

It is an object of the invention to shorten the time that a user who wishes to operate the vehicle must wait in order to be able to start it.

This and other objects and advantages are achieved by the method and apparatus according to the invention, which provides the ability to uncouple (with respect to space and/or time) a command to start the fuel cell system from the driver's presence, particularly from presence in the vehicle. As a result, the waiting time between the initiation of a starting operation and operability of the motor vehicle can be reduced. By means of the suggested invention, it is also possible to initiate a starting preparation for additional components of the motor vehicle. A starting preparation in this case is particularly the start of the operation of an APU (auxiliary power unit) which takes over the on-board power supply even before the vehicle is entered and adjusts, for example, the vehicle interior or vehicle parts, such a seats, windows, steering wheel, to a desired temperature.

According to a first preferred embodiment of the system according to the invention, the devices for initiating the starting operation have a wireless remote control, (particularly an infrared remote control), and a corresponding device for receiving remote control signals and for initiating the starting operation of the fuel cell system. Such an infrared control can be designed, for example, similar to the known remote-controlled central locking systems. It is also possible to provide a wireless connection with equipment outside or inside the vehicle which is normally operated or used shortly before the start of the vehicle. This equipment may consist, for example, of a garage door, a garage light, an alarm clock, a central door lock locking system or a seat belt. For example, when a garage door is operated, a wireless connection can be established between a transmitter that is in an operative connection with the garage door, and a receiver that is in an operative connection with the fuel cell system.

According to another preferred embodiment of the invention, a time-switch clock is provided by way of which the point in time of the next desired start of the vehicle can be entered. Such a time-switch clock can be arranged, for example, in the vehicle or, as an alternative, can interact with corresponding receiver devices by way of remote data transmission devices.

According to another preferred embodiment, devices are provided for connecting a device for initiating the starting operation of the fuel cell system with a telecommunication network, particularly the GSM or Internet. By means of such devices, it is possible to initiate or program the starting operation, for example, by way of mobile telephones or by way of an Internet connection.

After the initiation of a starting operation of the fuel cell system, it is also possible to provide for a change to a standby or warm-holding mode. This was found to be particularly advantageous when a time period which is longer than originally expected exists between the starting command and the actual starting of the motor vehicle, for example, because of unforeseen events.

Remote control via a mobile telephone or Internet e-mail can be constructed such that the momentary operating condition can be freely adjusted by way of these media. For example, a “warm-holding” condition could be stopped when the driver decides not to use the vehicle for an extended time but happens not to be at the location of the vehicle. Likewise, the vehicle itself can “ask” whether a certain operating condition is desired. It is, for example, conceivable to query the driver after an extensive warm-holding while the vehicle is stopped, whether a continued warm-holding or a cooling of the system is desired.

The above-mentioned functions may be constructed with a self-learning functionality which adapts itself to the driver profile or, in the event of atypical driver behavior, generates corresponding queries to the driver.

The provision according to the invention of a remote-controlled start and/or a start which can be programmed or preprogrammed with respect to time can reduce the demands on the starting behavior of a fuel cell system; that is, on the whole, in cost reductions, possibly in lower emissions, lower material strains (for example, as a result of thermal tensions) and in a lower fuel consumption.

Other objects, advantages and novel features of the present invention will become apparent from the following detailed description of the invention when considered in conjunction with the accompanying drawings.

### BRIEF DESCRIPTION OF THE DRAWINGS

FIG. 1 is a simplified schematic block diagram which illustrates significant components of the system according to the invention; and

FIG. 2 is a simplified flow chart which shows significant steps of the method according to the invention.

### DETAILED DESCRIPTION OF THE DRAWINGS

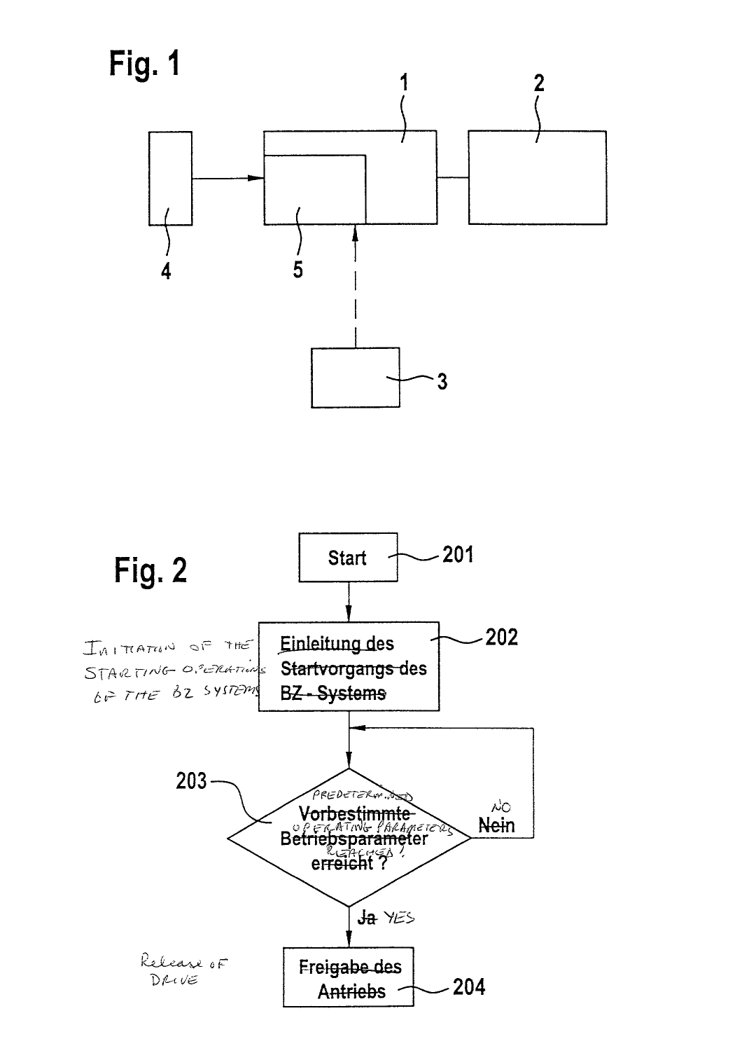

FIG. 1 illustrates a fuel cell system 1 and a vehicle drive 2 which is operatively connected therewith. Activation of the drive 2 is possible only when the fuel cell system, after the implementation of a starting operation, has reached a certain operating temperature. (In this case, the operating temperature or the idling power are mentioned, for example.)

A device 3 for wireless initiation of a starting operation of the fuel cell system 1 may be for example, an infrared remote control. The infrared remote control 3 can be operated to initiate the starting operation of the fuel cell system 1, even before the driver or user of the vehicle has sat down in the vehicle. This means that the driver need not wait in the car the entire time required for the starting operation. Since conventionally starting times last more than 30 seconds, user comfort is considerably improved in comparison to conventional arrangements.

Reference number 4 finally indicates a time-switch clock which is in an operative connection with the fuel cell system 1. This time-switch clock 4 can be arranged particularly inside the motor vehicle, so that, for example, before leaving the vehicle, the driver can enter the time of a desired next start.

The devices 3, 4 expediently interact with a device 5 representing a part of the fuel cell system. This device 5 has receiving devices for receiving the respective signals of the devices 3 and 4 respectively, as well as for generating corresponding starting signals for starting the fuel cell system. It is conceivable to construct the device 5 with receiving devices for Internet data or mobile radio data.

A preferred embodiment of the method according to the invention will now be explained by reference to FIG. 2. The method is started by operating the infrared remote control 3 of the fuel cell system 1 by means of a control device which is not shown (Step 201). However, the method can also be started when the fuel cell system 1 recognizes that an external or internal apparatus, which normally is operated or used shortly before the start of the vehicle, was in fact operated.

The start of the fuel cell system will then be initiated in a subsequent Step 202. For example, a reformer, which is assigned to or connected in front of a fuel cell system, is brought to an operating temperature. If it is found in Step 203 that predetermined operating parameters which are required for the faultless operation of the fuel cell system have been reached, the drive of the vehicle is released (Step 204) which is in an operative connection with the fuel cell system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Apparatus for starting a vehicle powered by a fuel cell system, comprising:
at least one device for initiating one of a starting operation of the fuel cell system and a starting preparation of the vehicle, independently of the presence or absence of a driver proximate to the vehicle.

2. The apparatus according to claim 1, wherein:
the at least one device for initiating the starting operation or the starting preparation is constructed in a wireless manner, particularly in the form of an infrared remote control, the devices being constructed with a corresponding receiver.

3. The apparatus according to claim 2, wherein said at least one device comprises:
a remote control unit; and
a receiver for receiving signals for initiating the starting operation, the receiver being in an operative connection with the fuel cell system.

4. The apparatus according to claim 1, further comprising a time-switch clock (4) for entering a next desired start time for the fuel cell system or of the vehicle.

5. The apparatus according to claim 1, further comprising means for connecting a device for initiating a starting operation of the fuel cell system via a telecommunication network.

6. The apparatus according to claim 5, wherein said telecommunications network comprises one of the GSM and the internet.

7. A method for starting a vehicle operated by a fuel cell system, comprising:
initiating one of a starting operation of the fuel cell system and a starting preparation of the motor vehicle independently of presence of the driver of the vehicle in the direct proximity of the vehicle.

8. The method according to claim 7, further comprising: after conclusion of a starting operation of the fuel cell system, changing to a standby or warm-holding condition.

9. A vehicle comprising:
a vehicle drive unit;
a fuel cell for powering said vehicle drive unit; and
a device for starting operation of said fuel cell independently of presence or absence of an operator of said vehicle.

10. A vehicle according to claim 9, wherein said device for starting operation comprises:
at least one component for generating a signal for starting said fuel cell independently of presence or absence of said operator; and
a receiver coupled to said fuel cell for initiating starting of said fuel cell in response to receipt of a signal from said at least one component.

11. The vehicle according to claim 10, wherein said at least one component comprises at least one of a presettable timer and a remotely operable transmitter for generating said signal.

12. A method for starting a vehicle that is powered by a fuel cell, comprising:
generating a starting signal independently of presence or absence of a vehicle operator in proximity to said vehicle; and
starting operation of said fuel cell in response to said starting signal.

13. The method according to claim 12, wherein said step of generating a starting signal comprises one of:
activation of a wireless remote control unit by said vehicle operator; and
occurrence of a preset time measured by a timer that is set by said operator.

14. The method according to claim 13, wherein said actuation of said wireless remote control unit is coupled to actuation of other equipment by said operator.

15. The method according to claim 14, wherein said other equipment comprises at least one of:
a garage door;
a garage light;
an alarm clock;
a central door locking system; and
a seat belt system.
